(19) United States
(12) Patent Application Publication
(10) Pub. No.: US 2011/0014947 A1
(43) Pub. Date: Jan. 20, 2011

(54) System and Method for Transferring the Operation of an Image Device to an External Apparatus

(76) Inventor: Hui-Hu LIANG, Siu Shui Hsiang (TW)

Correspondence Address: Jackson Intellectual Property Group PLLC, 106 Starvale Lane, Shipman, VA, 22971, US

(21) Appl. No.: 12/344,656

(22) Filed: Dec. 29, 2008

(51) Int. Cl. G09G 5/00; G06F 13/10; H04M 1/00

(52) U.S. Cl. 455/557; 710/62; 345/660

(57) ABSTRACT

A system and method for transferring the operation of an image device to an external apparatus includes an image device, the image device transmitting an image to a liquid crystal display (LCD) via a signal transmission; a central processing unit (CPU), the CPU being built in the image device and installed with a software driver program, the software driver program enabling the CPU to magnify and display the image on the LCD via the signal transmission; and a keyboard, the keyboard being connected with the CPU for controlling the software driver program installed in the CPU, the cursor of the keyboard being displayed at a relative position of the image, the keyboard being adapted for direct operating on the image corresponding to the operation of the image device. The present invention is convenient in use, quick and easy for operation, and convenient for portability.

### BACKGROUND OF THE INVENTION

1. Field of the Invention

The present invention relates to a system and method for transferring the operation of a device to an external apparatus, and more particularly to a system and method for transferring the operation of an image device to an external apparatus.

2. Description of the Prior Art

A conventional wireless cell phone, personal digital assistant (PDA), personal computer (PC), or notebook uses a USB for signal transmission, and then uses synchronous data transmission software to access its data to the PC. The data is amended or added via the Word software of the PC and then inputted into the central processing unit (CPU) of the original wireless cell phone or PDA to store such that the date is overwritten again.

The existing technique has the following shortcoming:

1. Because the wireless cell phone, PDA, or PC needs larger space, it is unable to access the data at any time. This is inconvenient in use.

2. A projector needs a PC or notebook to access the date of the wireless cell phone or the PDA, and then its signal is transmitted to the projector via the PC or notebook. The projector magnifies and displays the image on a projector screen. This operation is complicated and needs larger space.

3. The screen and the keys of the wireless cell phone or the PDA are small, which is hard to watch and inconvenient for fingers to operate and may cause an error. This is not practical and inconvenient in use.

### SUMMARY OF THE INVENTION

The primary objective of the present invention is to overcome the shortcomings of the prior art, providing a system and method for transferring the operation of an image device to an external apparatus. The present invention comprises an image device having a display image, such as a wireless cell phone, a PDA or a game machine, to couple with a mini projector, a keyboard and a mouse. The image of the wireless cell phone, the PDA or the game machine is transmitted to a liquid crystal display (LCD) via signal transmission, and the operation is transferred to the keyboard or the mouse. Alternatively, the image of the wireless cell phone, the PDA or the game machine is magnified and projected through the mini projector to a projector screen. The keyboard or the mouse is used to control the magnified image, such as to add, amend or save the image. The present invention is convenient in use, quick and easy for operation, and convenient for portability.

According to a first aspect of the present invention, there is provided a system for transferring the operation of an image device to an external apparatus, comprising: an image device, the image device transmitting an image to a liquid crystal display (LCD) via a signal transmission; a central processing unit (CPU), the CPU being built in the image device and installed with a software driver program, the software driver program enabling the CPU to magnify and display the image on the LCD via the signal transmission; and a keyboard, the keyboard being connected with the CPU for controlling the software driver program installed in the CPU, the cursor of the keyboard being displayed at a relative position of the image, the keyboard being adapted for direct operating on the image corresponding to the operation of the image device.

Preferably, the image device is one of a wireless cell phone, a personal digital assistant (PDA) and a game machine which have a screen to display.

Preferably, the keyboard is connected with a mouse, the cursor of the mouse being displayed at the relative position of the image simultaneously, the mouse being adapted for direct operating on the image corresponding to the operation of the image device.

Preferably, the signal transmission is transmitted via a Bluetooth wireless transmission device or a universal serial bus (USB) signal transmission line, the Bluetooth wireless transmission device or the USB signal transmission line enabling the image device, the keyboard and the mouse to constitute a signal transmission mode.

Preferably, the keyboard or the mouse is used to click on the image direct for making or answering a phone call of the wireless cell phone through an earphone connected with the keyboard or a speaker and a microphone provided on the keyboard.

According to a second aspect of the present invention, there is provided a system for transferring the operation of an image device to an external apparatus, comprising: an image device, the image device being connected with a mini projector via a signal transmission for transmitting an image to a projector screen; a central processing unit (CPU), the CPU being built in the image device and installed with a software driver program, the software driver program enabling the CPU to magnify and display the image on the projector screen of the mini projector via the signal transmission; and a keyboard, the keyboard being connected with the CPU for controlling the software driver program installed in the CPU, the cursor of the keyboard being displayed at a relative position of the image, the keyboard being adapted for direct operating on the image corresponding to the operation of the image device.

According to a third aspect of the present invention, there is provided a method for transferring the operation of an image device to an external apparatus, comprising the steps of:

(a) installing a software driver program in a central processing unit (CPU) of an image device;

(b) using a universal serial bus (USB) signal transmission line to connect the CPU to a liquid crystal display (LCD);

(c) using a keyboard or a mouse to connect with the CPU of the image device via the USB signal transmission line, or using a Bluetooth wireless transmission device to connect with the CPU of the image device;

(d) magnifying and displaying an image of the image device on the LCD via the CPU connected with the USB signal transmission line; and

(e) displaying the cursor of the keyboard or the mouse at a relative position of the image for adding, amending, or saving the image direct.

According to a fourth aspect of the present invention, there is provided a method for transferring the operation of an image device to an external apparatus, comprising the steps of:

(a) installing a software driver program in a central processing unit (CPU) of an image device;

(b) using a universal serial bus (USB) signal transmission line to connect the CPU to a mini projector;

(c) using a keyboard or a mouse to connect with the CPU of the image device via the USB signal transmission line, or using a Bluetooth wireless transmission device to connect with the CPU of the image device;

(d) magnifying and displaying an image of the image device on a projector screen via the CPU connected with the USB signal transmission line; and

(e) displaying the cursor of the keyboard or the mouse at a relative position of the image for adding, amending, or saving the image direct.

Preferably, the keyboard is connected with the mouse, the cursor of the mouse being displayed at the relative position of the image simultaneously, the mouse being adapted for direct operating on the image corresponding to the operation of the image device.

Preferably, the image device is one of a wireless cell phone, a personal digital assistant (PDA) and a game machine which have a screen to display.

Preferably, the keyboard or the mouse is used to click on the image direct for making or answering a phone call of the wireless cell phone through an earphone connected with the keyboard or a speaker and a microphone provided on the keyboard.

Compared to the prior art, the advantage of the present invention is that the image of the image device is transmitted to the LCD for displaying via the CPU and the keyboard or the mouse is used to control the operation of the image device, which is convenient in use, quick and easy for operation, and convenient for portability.

### BRIEF DESCRIPTION OF THE DRAWINGS

FIG. 1 is a block diagram of a system of the present invention;

FIG. 1A is a schematic view of the present invention showing the connection of a wireless cell phone and a keyboard/mouse;

FIG. 1B is a schematic view of the present invention showing the connection of a PDA and a keyboard/mouse;

FIG. 1C is a schematic view of the present invention showing the connection of the wireless cell phone coupled with a mini projector and the keyboard/mouse;

FIG. 1D is a schematic view of the present invention showing the connection of the PDA coupled with the mini projector and the keyboard/mouse;

FIG. 2A is a schematic view of the present invention showing the connection of the wireless cell phone and a LCD as well as the keyboard or the mouse connected with a Bluetooth wireless device;

FIG. 2B is a schematic view of the present invention showing the connection of the PDA and the LCD as well as the keyboard or the mouse connected with the Bluetooth wireless device;

FIG. 2C is a schematic view of the present invention showing the connection of the wireless cell phone and the mini projector as well as the keyboard or the mouse connected with the Bluetooth wireless device;

and

FIG. 2D is a schematic view of the present invention showing the connection of the PDA and the mini projector as well as the keyboard or the mouse connected with the Bluetooth wireless device.

### DETAILED DESCRIPTION OF THE PREFERRED EMBODIMENTS

Embodiments of the present invention will now be described, by way of example only, with reference to the accompanying drawings.

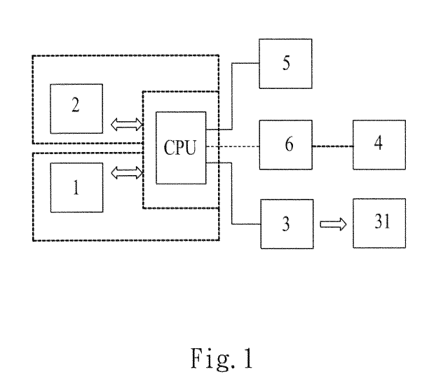

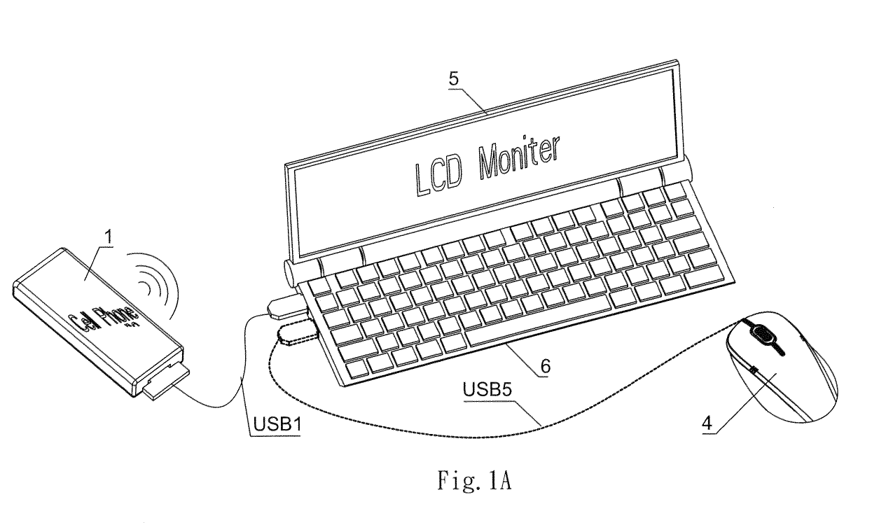

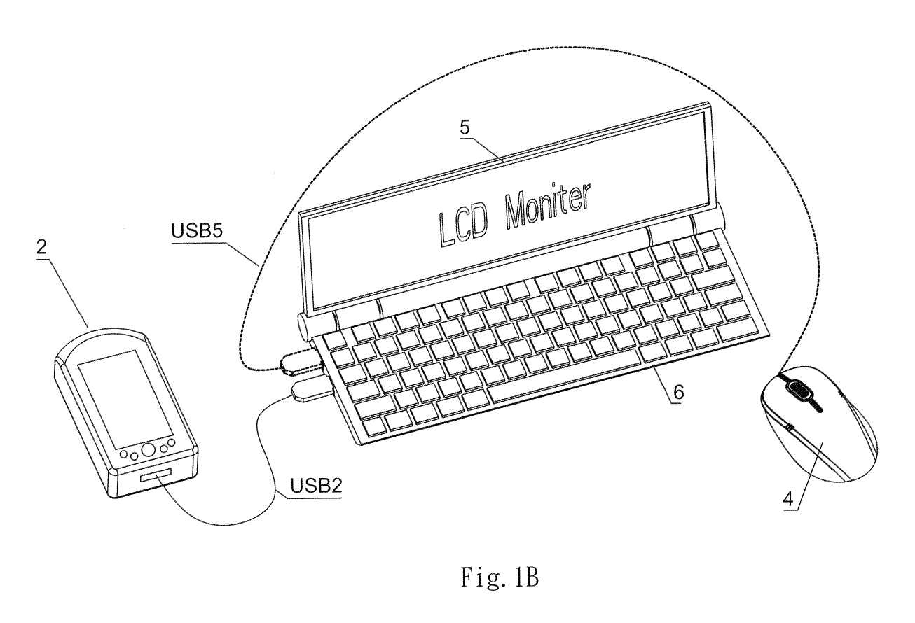

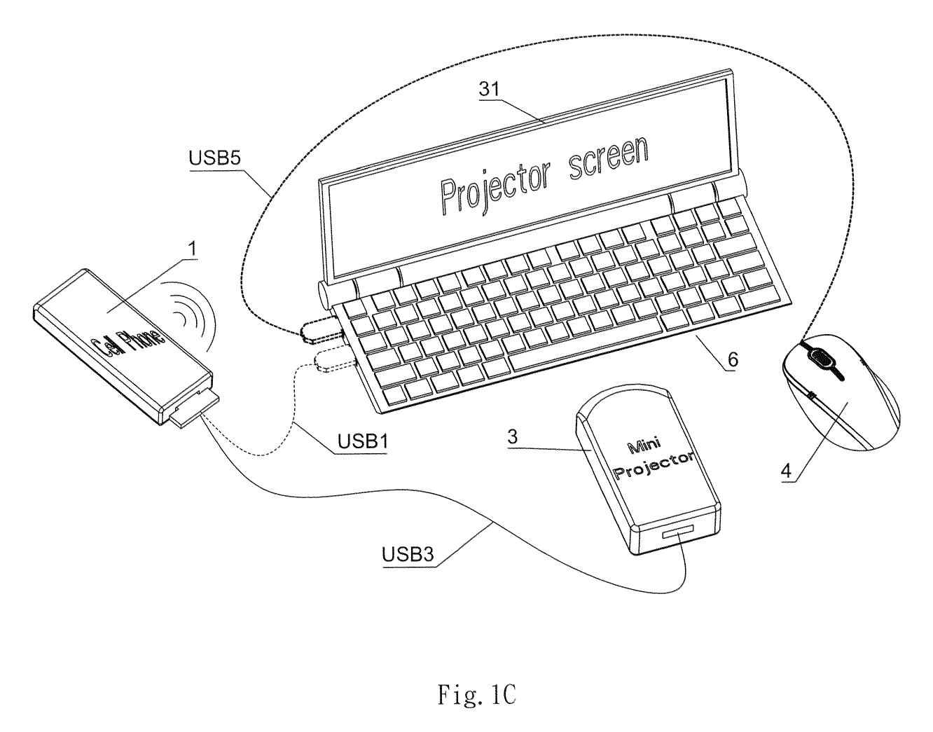

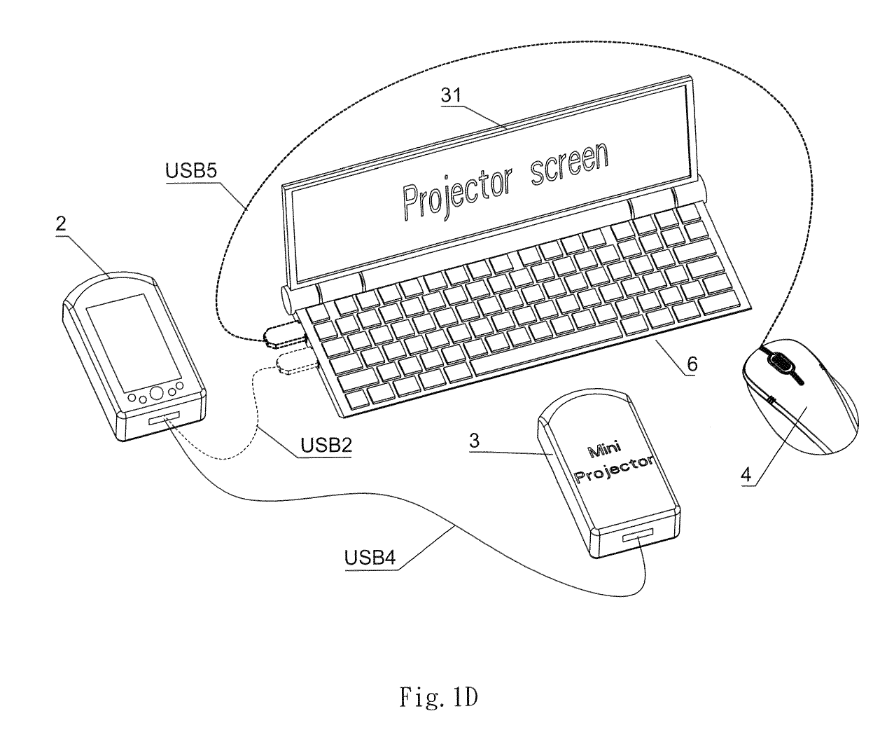

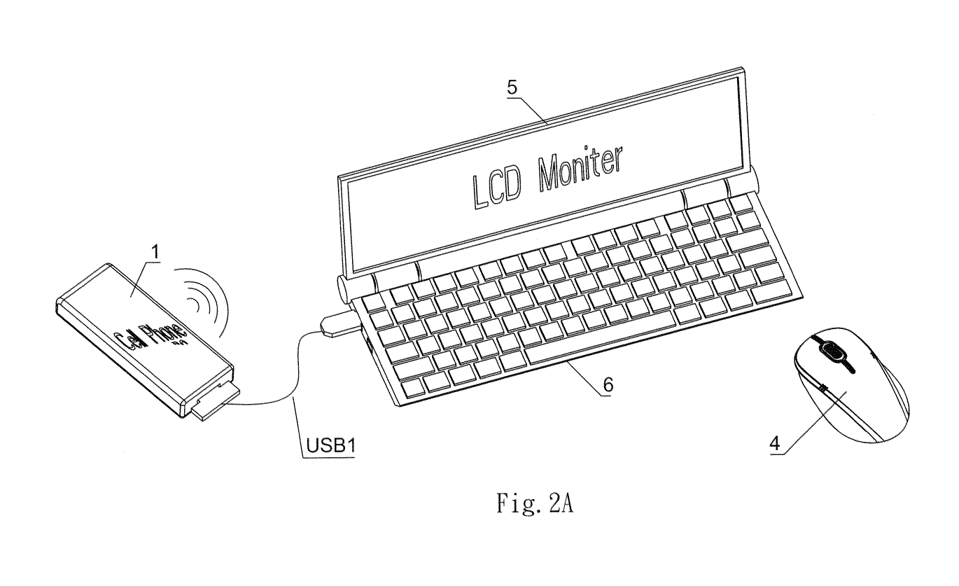

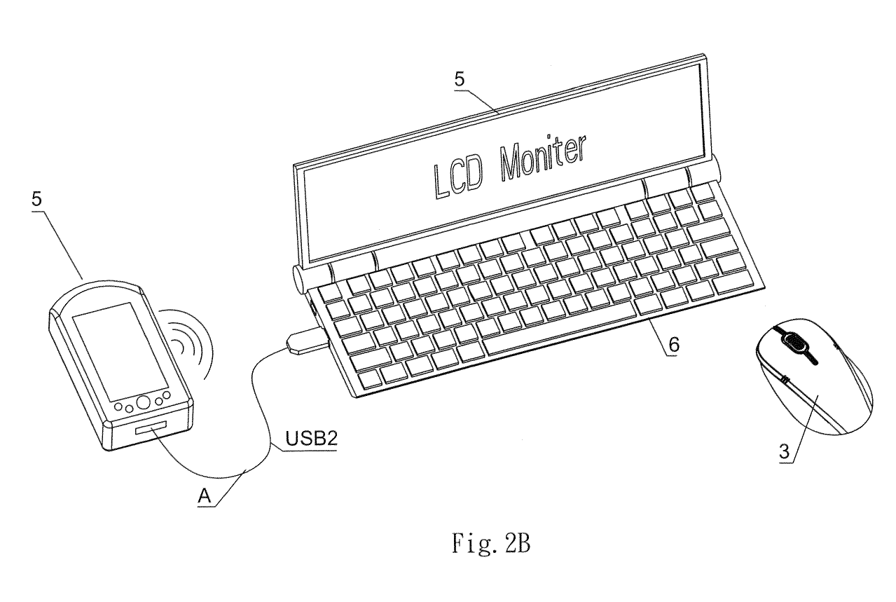

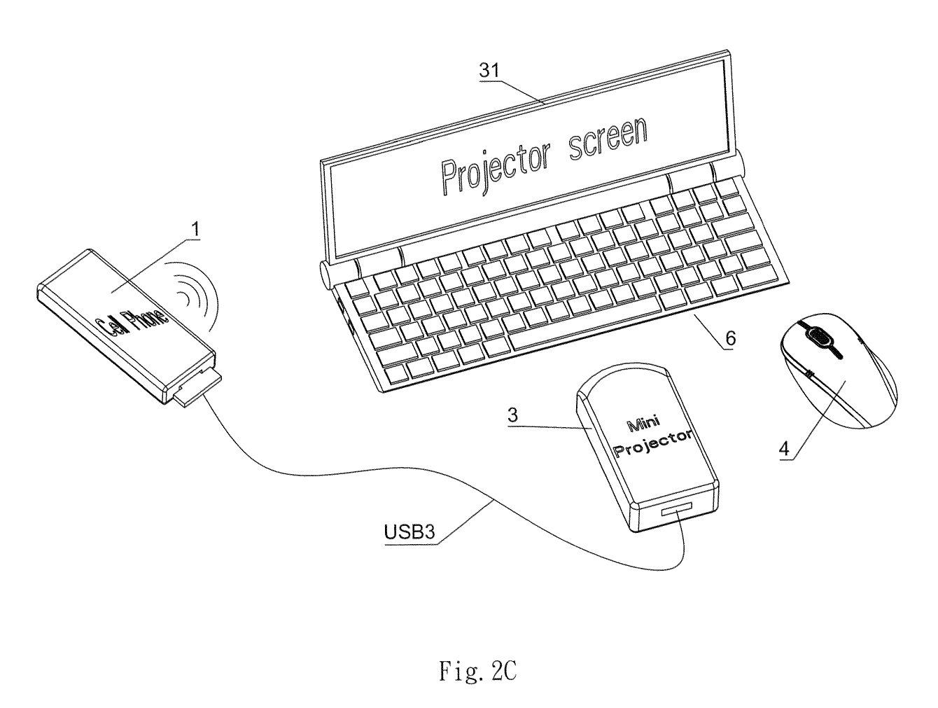

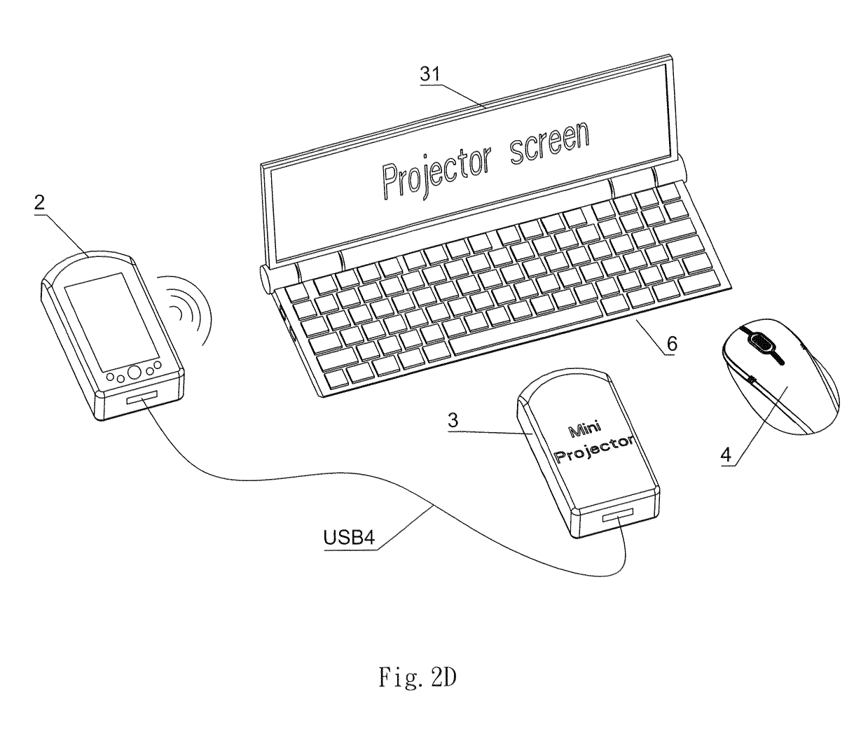

Referring to FIGS. 1, 1A˜D, 2A˜D, a system of the present invention comprises an image device having a display image, such as a wireless cell phone 1, a PDA (personal digital assistant) or a game machine 2, to couple with a mini projector 3, a mouse 4, and a keyboard 6. The image is transmitted to a liquid crystal display (LCD) 5 via USB signal transmission lines USB1 and USB2, as shown in FIGS. 1A, 1B, 2A, 2B; or the image is magnified and projected through the mini projector 3 to a projector screen 31 via USB signal transmission lines USB 3 and USB 4, as shown in FIGS. 1C, 1D, 2C, 2D. The keyboard 6 or the mouse 4 is used to control the cell phone 1, the PDA, or the game machine 2, such as to add, amend or save the image. The present invention is convenient in use, quick and easy for operation, and convenient for portability.

As shown in FIGS. 1A˜D, the USB signal transmission lines USB1˜5 are used to connect the wireless cell phone 1, the PDA or the game machine 2 with the mini projector 3, the keyboard 6 or the mouse 4 to constitute a signal transmission mode.

Referring to FIGS. 1, 1A, 1B, 2A, 2B, a software driver progress is installed in a central processing unit (CPU) of the cell phone 1, the PDA, or the game machine 2, and then the image of the wireless cell phone 1, the PAD, or the game machine 2 is transmitted to the LCD 5 via the USB signal transmission line USB1 (as shown in FIGS. 1A, 2A) or USB2 (as shown in FIGS. 1B, 2B). The USB signal transmission line USB1 is used to connect the CPU of the wireless cell phone 1 and the keyboard 6, as shown in FIG. 1A. The USB signal transmission line USB2 is used to connect the CPU of the PDA or the game machine 2 and the keyboard 6, as shown in FIG. 1B. The keyboard 6 and the mouse 4 are connected in series. The cursors of the keyboard 6 and the mouse 4 are located at a relative position of the image on the LCD 5 via the control of the keyboard 6 or the mouse 4, providing convenient operation and easy identification effects.

Referring to FIGS. 2A˜D, the wireless cell phone 1, the PDA or the game machine 2 may use a Bluetooth wireless transmission device to connect with the keyboard 6 and the mouse 4 (this is a conventional technique, and doesn't be described hereinafter) for providing a convenient operation.

Referring to FIGS. 1, 1C, 1D, 2C, 2D, the mini projector 3 of the present invention may use the USB signal transmission line USB3 to connect with the CPU of the wireless cell phone 1 (as shown in FIGS. 1C, 2C) or the USB signal transmission line USB4 to connect with the CPU of the PDA or the game machine 2 (as shown in FIGS. 1D, 2D), and use the projector screen 31 instead of the LCD 5 so that the image of the wireless cell phone 1, the PDA or the game machine 2 is projected on the projector screen 31. The cursor of the keyboard 6 or the mouse 4 is at a relative position of the image via the USB signal transmission line USB5 (as shown in FIGS. 1C, 1D) or the Bluetooth wireless transmission device (as shown in FIGS. 2C, 2D) for operation on a big screen of the projection, providing an exact, convenient, and quick use.

Referring to the FIGS. 1, 1A˜D, 2A˜D, a method of the present invention comprises the steps of:

(a) installing a software driver program in a CPU of a wireless cell phone 1, a PDA, or a game machine 2;

(b) using USB signal transmission lines USB 1˜4 or a Bluetooth wireless transmission device to connect the CPU to a LCD 5;

(c) using a keyboard 6 connected with a mouse 4 to connect with the CPU of the wireless cell phone 1, the PDA, or the game machine 2 via the USB signal transmission line USB1 or USB, or using a Bluetooth wireless transmission device to connect with the CPU of the wireless cell phone 1, the PDA, or the game machine 2;

(d) magnifying and displaying an image of the wireless cell phone 1, the PDA, or the game machine 2 on the LCD 5 via the USB signal transmission line USB1 or USB 2; and

(e) displaying the cursor of the keyboard 6 or the mouse 4 at a relative position of the image to control the image direct, such as to add, amend, or save.

Accordingly, the image of the wireless cell phone 1, the PDA, or the game machine 2 is magnified and transmitted to LCD 5 for displaying via the CPU, and the keyboard 6 or the mouse 4 is used to operate the existing functions of the wireless cell phone 1, the PDA, or the game machine 2. The present invention provides the effects of convenient use, quick and easy operation, and convenient portability.

Referring to FIGS. 1, 1C, 1D, 2C, 2D, the mini projector 3 of the present invention may use the USB signal transmission line USB 3 to connect with the CPU of the wireless cell phone 1 (as shown in FIGS. 1C, 2C) or the USB signal transmission line USB 4 to connect with the CPU of the PDA or the game machine 2 (as shown in FIGS. 1D, 2D), and use the projector screen 31 instead of the LCD 5 so that the image of the wireless cell phone 1, the PDA or the game machine 2 is projected on the projector screen 31. The cursor of the keyboard 6 or the mouse 4 is at a relative position of the image via the USB signal transmission line

USB5 (as shown in FIGS. 1C, 1D) or the Bluetooth wireless transmission device (as shown in FIGS. 2C, 2D) for operation on a big screen of the projection, providing an exact, convenient, and quick use.

Referring to FIGS. 1, 1A, 1C, 2A, 2C, when the wireless cell phone 1, the keyboard 6 and the mouse 4 are in use, the keyboard 6 or the mouse 4 will be used to click on the image direct for answering the phone so that the phone call of the wireless cell phone 1 is transmitted to an earphone provided on the keyboard 6 or a built-in speaker and microphone for answering the phone (existing equipment on the keyboard 6). This is convenient in use.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A system for transferring the operation of an image device to an external apparatus, comprising:
an image device, the image device transmitting an image to a liquid crystal display (LCD) via a signal transmission;
a central processing unit (CPU), the CPU being built in the image device and installed with a software driver program, the software driver program enabling the CPU to magnify and display the image on the LCD via the signal transmission; and
a keyboard, the keyboard being connected with the CPU for controlling the software driver program installed in the CPU, the cursor of the keyboard being displayed at a relative position of the image, the keyboard being adapted for direct operating on the image corresponding to the operation of the image device.

2. The system for transferring the operation of an image device to an external apparatus as claimed in claim 1, wherein the image device is one of a wireless cell phone, a personal digital assistant (PDA) and a game machine which have a screen to display.

3. The system for transferring the operation of an image device to an external apparatus as claimed in claim 1, wherein the keyboard is connected with a mouse, the cursor of the mouse being displayed at the relative position of the image simultaneously, the mouse being adapted for direct operating on the image corresponding to the operation of the image device.

4. The system for transferring the operation of an image device to an external apparatus as claimed in claim 1, wherein the signal transmission is transmitted via a Bluetooth wireless transmission device or a universal serial bus (USB) signal transmission line, the Bluetooth wireless transmission device or the USB signal transmission line enabling the image device, the keyboard and the mouse to constitute a signal transmission mode.

5. The system for transferring the operation of an image device to an external apparatus as claimed in claim 2, wherein the keyboard or the mouse is used to click on the image direct for making or answering a phone call of the wireless cell phone through an earphone connected with the keyboard or a speaker and a microphone provided on the keyboard.

6. A system for transferring the operation of an image device to an external apparatus, comprising:
an image device, the image device being connected with a mini projector via a signal transmission for transmitting an image to a projector screen;
a central processing unit (CPU), the CPU being built in the image device and installed with a software driver program, the software driver program enabling the CPU to magnify and display the image on the projector screen of the mini projector via the signal transmission; and
a keyboard, the keyboard being connected with the CPU for controlling the software driver program installed in the CPU, the cursor of the keyboard being displayed at a relative position of the image, the keyboard being adapted for direct operating on the image corresponding to the operation of the image device.

7. The system for transferring the operation of an image device to an external apparatus as claimed in claim 6, wherein the keyboard is connected with a mouse, the cursor of the mouse being displayed at the relative position of the image simultaneously, the mouse being adapted for direct operating on the image corresponding to the operation of the image device.

8. The system for transferring the operation of an image device o an external apparatus as claimed in claim 6, wherein the image device is one of a wireless cell phone, a personal digital assistant (PDA) and a game machine which have a screen to display.

9. The system for transferring the operation of an image device to an external apparatus as claimed in claim 6, wherein the signal transmission is transmitted via a Bluetooth wireless transmission device or a universal serial bus (USB) signal transmission line, the Bluetooth wireless transmission device or the USB signal transmission line enabling the image device, the keyboard and the mouse to constitute a signal transmission mode.

10. A method for transferring the operation of an image device to an external apparatus, comprising the steps of:
(a) installing a software driver program in a central processing unit (CPU) of an image device;
(b) using a universal serial bus (USB) signal transmission line to connect the CPU to a liquid crystal display (LCD);
(c) using a keyboard or a mouse to connect with the CPU of the image device via the USB signal transmission line, or using a Bluetooth wireless transmission device to connect with the CPU of the image device;
(d) magnifying and displaying an image of the image device on the LCD via the CPU connected with the USB signal transmission line; and
(e) displaying the cursor of the keyboard or the mouse at a relative position of the image for adding, amending, or saving the image direct.

11. The method for transferring the operation of an image device to an external apparatus as claimed in claim 10, wherein the keyboard is connected with the mouse, the cursor of the mouse being displayed at the relative position of the image simultaneously, the mouse being adapted for direct operating on the image corresponding to the operation of the image device.

12. The method for transferring the operation of an image device to an external apparatus as claimed in claim 10, wherein the image device is one of a wireless cell phone, a personal digital assistant (PDA) and a game machine which have a screen to display.

13. A method for transferring the operation of an image device to an external apparatus, comprising the steps of:
(a) installing a software driver program in a central processing unit (CPU) of an image device;
(b) using a universal serial bus (USB) signal transmission line to connect the CPU to a mini projector;
(c) using a keyboard or a mouse to connect with the CPU of the image device via the USB signal transmission line, or using a Bluetooth wireless transmission device to connect with the CPU of the image device;
(d) magnifying and displaying an image of the image device on a projector screen via the CPU connected with the USB signal transmission line; and
(e) displaying the cursor of the keyboard or the mouse at a relative position of the image for adding, amending, or saving the image direct.

14. The method for transferring the operation of an image device to an external apparatus as claimed in claim 13, wherein the keyboard is connected with the mouse, the cursor of the mouse being displayed at the relative position of the image simultaneously, the mouse being adapted for direct operating on the image corresponding to the operation of the image device.

15. The method for transferring the operation of an image device to an external apparatus as claimed in claim 13, wherein the image device is one of a wireless cell phone, a personal digital assistant (PDA) and a game machine which have a screen to display.

16. The method for transferring the operation of an image device to an external apparatus as claimed in claim 15, wherein the keyboard or the mouse is used to click on the image direct for making or answering a phone call of the wireless cell phone through an earphone connected with the keyboard or a speaker and a microphone provided on the keyboard.
